(19) United States
(12) Patent Application Publication
(10) Pub. No.: US 2005/0234616 A1
(43) Pub. Date: Oct. 20, 2005

(54) Systems and methods for remotely communicating with a vehicle

(76) Inventors: Marc Oliver, West Jordan, UT (US); Mark Haslam, Bountiful, UT (US)

Correspondence Address: TRASK BRITT, P.O. BOX 2550, SALT LAKE CITY, UT, 84110, US

(21) Appl. No.: 10/827,661

(22) Filed: Apr. 19, 2004

(51) Int. Cl. G06F 19/00

(52) U.S. Cl. 701/33; 701/29; 340/438

(57) ABSTRACT

The present invention discloses vehicle diagnostic systems and, more particularly, methods and systems for remotely retrieving vehicle data from a vehicle with a computer-based diagnostic application. A method of retrieving vehicle data from a vehicle includes establishing a first connection between a host computer and a computer network, establishing a second connection between an onboard computer of a vehicle and the computer network, and transferring vehicle data over the computer network. Systems and apparatuses for performing the methods of the present invention are also described.

### TECHNICAL FIELD

The present invention relates generally to vehicle diagnostic systems and, more particularly, to methods and systems for remotely retrieving vehicle data from a vehicle by using a computer-based diagnostic technique.

### BACKGROUND

The use of a diagnostic application periodically to gather information from a vehicle engine or other system of the vehicle is known. For instance, to perform a diagnostic examination of a truck, the truck is brought to a service bay where a truck mechanic performs the diagnostic examination. This examination is performed by directly connecting an in-bay service computer to a microprocessor or similar component associated with a truck, such as an on-board engine control module. The connection is accomplished by running a hard wire from the service computer to the microprocessor of the truck's engine control module.

The service technician uses a software application of the in-bay service computer to communicate with each microprocessor of a control module aboard the truck. The component's microprocessor is configured to control or gather information from various sensors of the component control module, and to store various messages generated by the components or sensors of the truck. The various on-board components of the truck generate and store messages, such as fault codes, during operation of the truck. A representative example of how an onboard computer communicates with sensors is discussed in U.S. Pat. No. 6,677,854, the contents of the entirety of which is incorporated herein by this reference. In this manner, if a component of the truck is not performing properly, such as if the engine of the truck is running too warm, the microprocessor of the engine control module can store data related to the under performance of the truck. When the truck is brought to the service bay and a hardwire is used to connect the in-bay service computer to the engine module microprocessor, the service technician is able to access the messages or fault codes stored in the engine module microprocessor with the diagnostic application of the service computer, thus, allowing the service technician to read the messages or fault codes and thereby diagnose any problems of the various systems of the truck.

Although performing the diagnostic examination in this manner allows the service technician to quickly access the data stored on the component module microprocessor, it requires that the truck physically be located proximate the service computer. Further, in order to perform such a diagnostic examination, the service technician needs to establish an individual connection with each truck to be diagnosed. To diagnose another truck, the service technician needs to disconnect the physical connection between the truck's computer system and the service computer before physically establishing a connection to another truck. This results in wasted time for the service technician.

### SUMMARY OF THE INVENTION

The instant invention generally involves a method of remotely performing a diagnostic session on a vehicle having an onboard computer. As used herein, the tem “diagnostic session” will be used to refer acts used by a diagnostic application on a computer to diagnose an on-board computer of vehicle. Thus, a “diagnostic session” includes acts of the diagnostic application sending and receiving data to and from the on-board computer. Generally, the method includes establishing a first connection between a host computer and a computer network such as, for example, the Internet, establishing a second connection between an onboard computer of a vehicle and the computer network, and transferring the vehicle data from the onboard computer of the vehicle to the host computer over the computer network. As used herein, the term “host computer” will be used to refer to a computer configured with a diagnostic application software program (hereinafter “diagnostic application”), wherein the computer configured with the diagnostic application “hosts” the diagnostic session. The onboard computer has the capability to retrieve and store vehicle data such as, for example, operational information about the vehicle that may be obtained from various component control modules associated with the vehicle. Thus, the remotely performed diagnostic session retrieves and diagnoses the same data and achieves the same results which occurred when the truck was sitting in a diagnostic computer equipped bay.

In one embodiment, a system for enabling a vehicle to remotely communicate with a host computer over a computer network is described. The system includes a protocol adapter for translating vehicle data generated by a vehicle component control module of the vehicle and a memory device operatively configured with a computer network driver for enabling an onboard computer of the vehicle to communicate over the computer network.

In an additional embodiment, a system for remotely performing a diagnostic session is described. The system includes a host computer operatively configured with a diagnostic application, a first computer network adapter driver for connecting the host computer to a computer network, and a first dynamic link library interface for enabling the host computer to communicate with an onboard computer of a vehicle. The system also includes the onboard computer associated with a vehicle component control module of a vehicle, wherein the onboard computer has memory operatively configured with a second computer network adapter driver for connecting the onboard computer to the computer network and a protocol adapter driver for communicating with a protocol adapter. The system further includes a protocol adapter for interconnecting the onboard computer and the host computer.

In yet a further embodiment, a system for remotely performing a diagnostic session includes a host computer operatively configured with a diagnostic application. The system further includes means for enabling the diagnostic application to retrieve vehicle data from an onboard computer associated with a vehicle over a computer network.

In another embodiment, a vehicle having a microprocessor capable of sensing and storing vehicle data is described, wherein a computer network adapter driver and a protocol adapter driver capable of interacting with the microprocessor are stored in memory of an onboard computer. A protocol adapter for interconnecting the onboard computer with a host computer and a means for connecting the onboard computer to the host computer over a computer network are further described in association with the vehicle.

In an additional embodiment, a method of performing a diagnostic session on a vehicle remotely located from a host computer configured with a diagnostic application is described. The method includes activating a connection between an onboard computer of the vehicle and a computer network capable of connecting to the host computer and accessing the computer network to establish communication between the onboard computer and the host computer. The method further includes performing the diagnostic session on the remotely located vehicle over the computer network by running the diagnostic application.

In each of the various embodiments described herein, means and systems are provided which enable an onboard computer system of a vehicle to connect with a computer network such as, for example, the Internet, when the vehicle is located at an Internet cafe at, for example, a truck stop. By connecting the onboard computer system of the vehicle with the computer network, a host computer is enabled to remotely retrieve vehicle data from the vehicle.

### BRIEF DESCRIPTION OF THE DRAWINGS

FIG. 1 is a schematic diagram of one embodiment of a communication system of the present invention.

FIG. 2 illustrates a schematic diagram of an additional embodiment of a communication system of the present invention.

FIG. 3 is a schematic diagram of another embodiment of a communication system of the present invention.

FIG. 4 depicts a schematic diagram of a further embodiment of a communication system of the present invention.

FIG. 5 is a schematic diagram of one embodiment of a vehicle data communication system of the present invention.

FIG. 6 is a schematic diagram of one embodiment of a method of providing a vehicle with an opportunity to purchase a diagnostic session.

FIG. 7 is a flowchart of one embodiment of a method of remotely performing a diagnostic session of the present invention.

### DETAILED DESCRIPTION

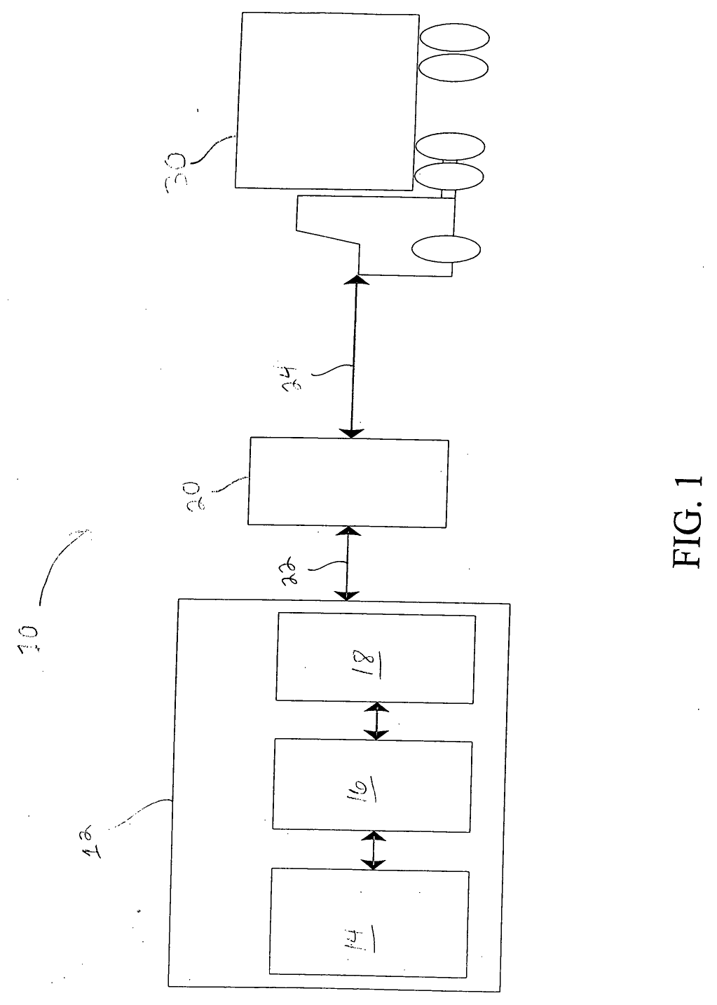

Referring to FIG. 1, there is shown a schematic diagram of one embodiment of a communication system 10 of the present invention. The communication system 10 includes a host computer 12, a protocol adapter 20, and a vehicle 30. The host computer 12 is configured with a diagnostic application 14 such as, for example, a vehicle component diagnostic software program that enables a user of the host computer 12 to acquire vehicle data from a microprocessor such as, for example, a microprocessor associated with a component control module of the vehicle 30. The vehicle data may be diagnostic data that includes, for example, operating information, diagnostic information, programmable parameters, engine control signals, transmission control signals, or braking system signals. In the embodiment of FIG. 1, the diagnostic application 14 is PC-based and written to use a RP1210A interface, but in other embodiments, the diagnostic application 14 may be supported by other computer operating systems and written to use other interfaces.

The term “vehicle data” as used herein includes, but is not limited to, operating information, diagnostic information, programmable parameters, engine control signals, transmission control signals, braking system signals, fault codes, engine rpm, idle speeds, fluid temperature, engine oil pressure, battery voltage, fuel rate, data generated by a sensor, vehicle tests, vehicle log and trip information, emissions information (i.e., such as NOx output) or any other input information, or electronic data accessible, gathered by or generated by an offboard or onboard microprocessor associated with the component control module of the vehicle 30.

The microprocessor may be operatively connected to sensors that are themselves operatively connected to various components of the engine, transmission, or other system of the vehicle 30. The sensors generate electric signals that correspond to the component that the sensors are connected to. The microprocessor may periodically retrieve the electric signals from the sensors and store the electric signals, thus generating vehicle data. In addition to receiving vehicle data, the microprocessor may also send electric signals to various components of the vehicle, wherein the sent electric signals are also stored, thus, generating vehicle data. For example, in one embodiment, an oil temperature sensor senses the oil temperature and generates electric signals corresponding to the oil temperature, wherein the oil temperature signals are sent to the microprocessor and stored as vehicle data.

The diagnostic application 14 obtains the vehicle data from the vehicle 30 through the use of a dynamic link library (DLL) interface 16, such as a RP1210A DLL interface or a RP1210 interface. The diagnostic application 14 enables a technician operating the diagnostic application 14 to retrieve the vehicle data from the vehicle 30. The DLL interface 16 enables the diagnostic application 14 to communicate with the protocol adapter 20 in a standardized manner. A protocol adapter driver 18 enables the function of allowing the DLL interface 16 to communicate with the protocol adapter 20. As used herein, the term “driver” will be used to refer to a software program or code that enables a component associated with a computer to perform a function.

In another embodiment, the host computer 12 is configured with software that enables the technician to send data to an onboard computer of the vehicle. In this manner, the technician is enabled to control or set parameters of a component control module of the vehicle or send data to the onboard computer of the vehicle. As used herein, the term “diagnostic session” will be used to refer to acts of the host computer sending or receiving data, such as vehicle data, to and from the onboard computer of the vehicle.

A connection 22 such as, for example, a serial or USB cable, physically connects the host computer 12 to the protocol adapter 20. The protocol adapter 20 may include, for example, an RS-232 interface, an ISA card, a PC/104 card, a TCP/IP interface, a RF interface, a USB interface, or any other protocol adapter 20 which performs functions the same as or similar to the protocol adapter 20 described herein. The protocol adapter 20 receives and arranges vehicle data from the microprocessor of the vehicle 30 through a vehicle network 24 (i.e., data bus) such as, for example, J1708, J1850, CAN, J1587, J1939, GMLAN, J1979, J2284, J2411, J1587, RP1210 or J1922. The protocol adapter 20 enables the function of allowing the vehicle network 24 to interconnect and communicate with the host computer 12 such as, for example, by arranging and delivering the vehicle data to the host computer 12 in a format that is readable by software, i.e., the diagnostic application 14, of the host computer 12.

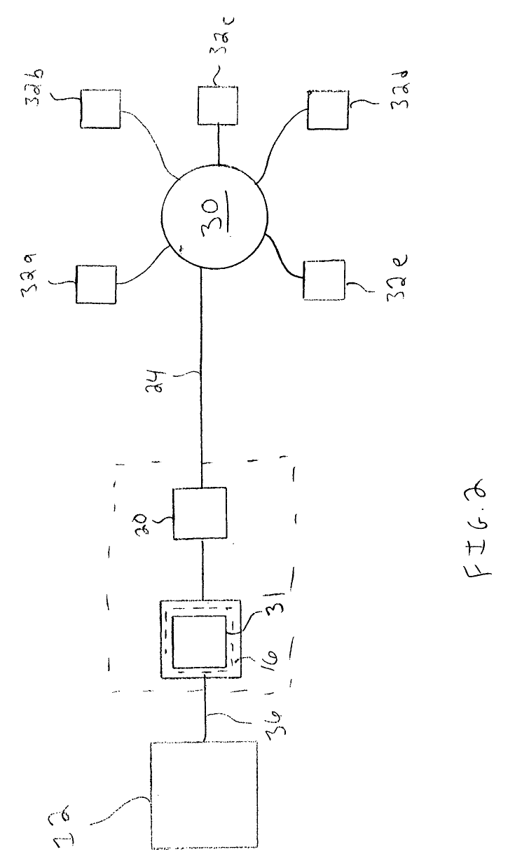

In another embodiment, the vehicle 30 may be further configured with an onboard computer 31 such as, for example, a laptop computer or an embedded PC, such as an embedded PC or Truck-PC available from DriverTech, of Salt Lake City, Utah, that is operatively connected to each vehicle component control module 32 as shown in FIG. 2 through a vehicle network. In the exemplary embodiment, the onboard computer 31 is operatively connected to a plurality of vehicle component control modules include a HVAC control module 32a, a brake control module 32b, a transmission control module 32c, an engine control module 32d, and a miscellaneous control module 32e which may comprise any other type of control module known by those of ordinary skill in the art to be associated with a vehicle 30.

The vehicle network 24 may be, for example, a J1708, a J1939 or a J1850. The vehicle network 24 is connected to a protocol adapter 20 which is operatively connected to the onboard computer 31, which may also be referred to as a vehicle PC. The onboard computer 31 is associated with a DLL interface 16 such as, for example, a RP1210A adapter, and communicates with a host computer 12 through a computer network 36 such as, for example, the Internet.

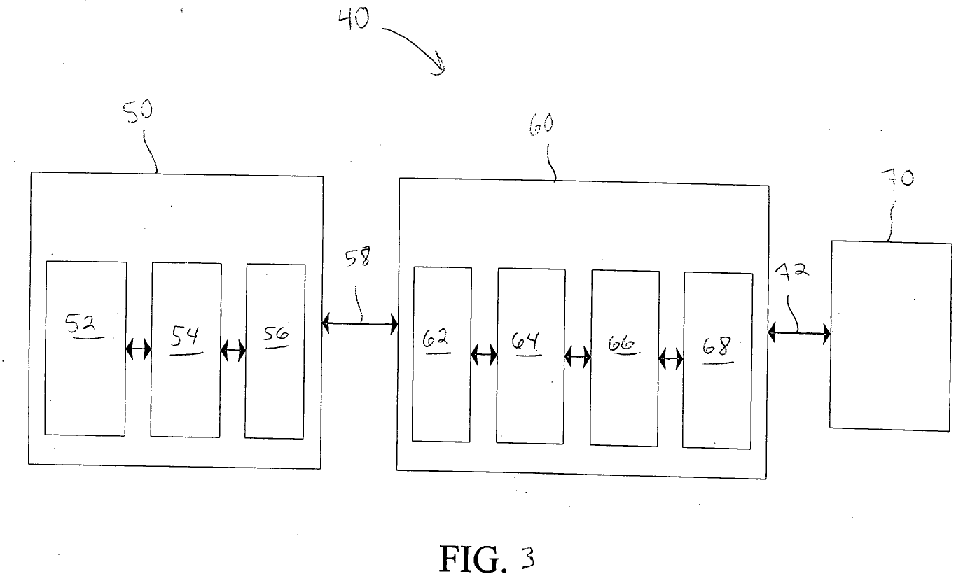

FIG. 3 illustrates a schematic diagram of another embodiment of a communication system 40 of the present invention. The communication system 40 includes a host computer 50, an onboard computer 60 and a vehicle component control module 70. The onboard computer 60 and the vehicle component control module 70 may be located on, or associated with, a vehicle which may be, for example, a truck, an automobile, a piece of heavy equipment, a piece of construction equipment, a farm machine, a military vehicle, an airplane, a hovercraft, a motorcycle, a boat, or any other piece of mobile equipment or mode of transportation. In other embodiments, the vehicle may be configured with a plurality of various component control modules 70 as previously described herein.

The host computer 50 may be, for example, a personal computer (such as a desktop or laptop computer), a personal digital assistant (PDA), a computer work station or any other conventional computer system that may be operatively configured with software and capable of running a diagnostic application 52, a first DLL interface 54 and a first computer network adapter driver 56. In the exemplary embodiment of FIG. 3, the diagnostic application 52 is a vehicle component diagnostic software program that enables a user of the host computer 50 to acquire the vehicle data from a microprocessor associated with the vehicle component control module 70 through of the onboard computer 60 associated with the vehicle.

In one embodiment, the diagnostic application 52 is PC-based and written to communicate with a conventional RP1210A interface. In other embodiments, the diagnostic application 52 may be written for other computer operating systems including, but not limited to, LINUX, WINDOWS, DOS or a MACINTOSH operating system. In this manner, the first computer network adapter driver 56 enables the function of allowing the technician to operate the diagnostic application 52 and perform a diagnostic session or retrieve vehicle data over a computer network 58 such as, for example, the Internet. The host computer 50 is connected to the computer network 58 with a means for connecting the host computer 50 to the computer network 58 such as, for example, a Wi-Fi computer network connection, a 1xRTT connection, a modem, an Ethernet connection, a wireless modem, a satellite based computer network connection, employing an internet service provider, a telephone line, a cable modem or any conventional method of connecting a computer to the computer network 58. In other embodiments, the computer network 58 may be a local area network (LAN) or a wide area network (WAN).

In one embodiment, the first DLL interface 54 and the first computer network adapter driver 56 are configured on a memory device such as, for example, a compact disk (CD), a floppy disk or any other conventional external storage device, and are downloaded from the external memory device into a memory device such as, for example, a hard disk of the host computer 50. The first DLL interface 54 and the first computer network adapter driver 56 are capable of communicating with the diagnostic application 52 of the host computer 50 such that the diagnostic application 52 does not need to be re-written or augmented.

The first DLL interface 54 may be, for example, a RP1210A DLL interface. Other DLL interfaces include, but are not limited to RP 1210, RP 12, RS 232 or other conventional interfaces. The first DLL interface 54 enables the function of allowing the diagnostic application 52 to communicate with a protocol adapter 68 associated with the onboard computer 60 of the vehicle in a standardized manner. In one embodiment, the first computer network adapter driver 56 comprises a software program that enables the function of allowing the first DLL interface 54 to send and receive signals via the computer network 58 or that extends the first DLL interface 54 over the computer network 58, such that the host computer 50 is capable of communicating with the onboard computer 60 of the vehicle over the computer network 58.

The onboard computer 60 comprises a memory device such as, for example, a hard drive configured with a second computer network adapter driver 62, a second DLL interface 64, and a protocol adapter driver 66. The onboard computer 60 is also associated with protocol adapter hardware 68 which enables the onboard computer 60 to interconnect and communicate with the host computer 50.

In one embodiment, the second internet adapter driver 62 comprises a software program that enables the function of allowing the second DLL interface 64 to send and receive signals via the computer network 58, such that the onboard computer 60 of the vehicle is enabled to communicate with the host computer 50 over the computer network 58. The second DLL interface 64 may be, for example, a RP1210A DLL interface which is an industry standard.

In one embodiment, the protocol adapter driver 66 is a software program that enables the function of arranging and delivering the vehicle data to the conventional DLL interface 64. The second computer network driver 62, the second DLL interface 64, the protocol adapter driver 66, or any combinations thereof may be provided on an external memory device and downloaded into memory of the onboard computer 60. The external memory device may comprise a CD, a floppy disk, or other external storage device. By downloading the second computer network driver 62, the second DLL interface 64 or the protocol adapter driver 66 into memory of the onboard computer 60, an existing onboard computer 60 of a vehicle may be adapted to communicate with the host computer 50.

The protocol adapter hardware 68 enables the onboard computer 60 of the vehicle to communicate with the host computer 50. The vehicle component control module 70 communicates with the protocol adapter hardware 68 with a vehicle network 72 such as, for example, J1708, J1850, CAN, J1587, J1939 or J1922. By providing the technician with the ability to perform the diagnostic session over the computer network 58 or retrieve vehicle data over the computer network 58, the technician is enabled to access multiple vehicles without the need to configure the onboard computer of each vehicle with the diagnostic application 52 or physically connect the host computer 50 to the onboard computer 60 of each vehicle.

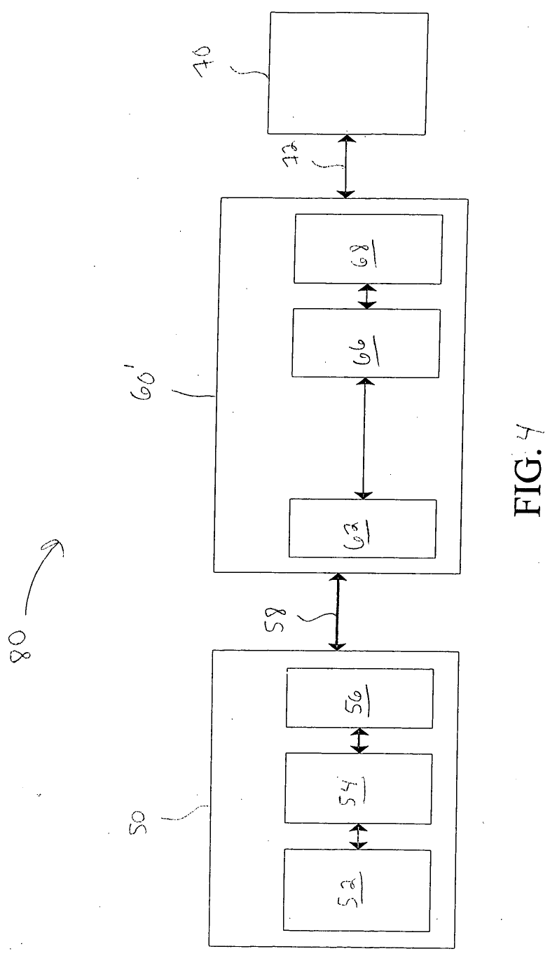

Another embodiment of a communication system 80 of the present invention is illustrated in the schematic diagram of FIG. 4. A host computer 50 of the communication system 80 of FIG. 4 is configured in substantially the same manner as the host computer 50 of FIG. 3 and includes a diagnostic application 52, a first DLL interface 54, and a first computer network adapter driver 56. The first DLL interface 54 and the first computer network adapter driver 56 may be provided on an external memory device and downloaded to memory of the host computer 50 such that the host computer 50 of FIG. 4 may be configured to communicate with an onboard computer 60′ of a vehicle.

Memory of the onboard computer 60′ is configured with a second internet adapter driver 62 and a protocol adapter driver 66, and is associated with protocol adapter hardware 68. The second internet adapter driver 62 or the protocol adapter driver 66 may be provided on an external memory device and downloaded to memory of the onboard computer 60′ of the vehicle, or in another embodiment, the memory of the onboard computer 60′ may be configured with the second internet adapter driver 62 or the protocol adapter driver 66 such that the onboard computer 60′ enables the function of communicating with the host computer 50.

A vehicle component control module 70 communicates with the protocol adapter hardware 68 with a vehicle network 72 (i.e., data bus) such as, for example, J1708, J1850, CAN, J1587, J1939 or J1922. In the embodiment of FIG. 4, the protocol adapter driver 66 comprises a software program that enables the function of arranging and formatting vehicle data received from the vehicle component control module 70, such that the second computer network adapter driver 62 may be enabled with the function of transmitting the vehicle data over the computer network 58 such as, for example, the Internet.

In order for the onboard computer 60 of the communication system 40 of FIG. 2 and the onboard computer 60′ of the communication system 80 of FIG. 3 to communicate with the host computer 50, the onboard computers 60 and 60′ are operatively connected to the computer network 58, i.e., the Internet, with a means for connecting the onboard computer 60 or 60′ to the computer network 58. The connection may be made using any conventional method of connecting a computer to a computer network including, but not limited to, a Wi-Fi computer network connection, a 1xRTT connection, a wireless modern, a satellite based computer network computer, a telephone line, an Ethernet connection, a cable modem or any conventional device or method of establishing a connection to the computer network, i.e., such as the Internet.

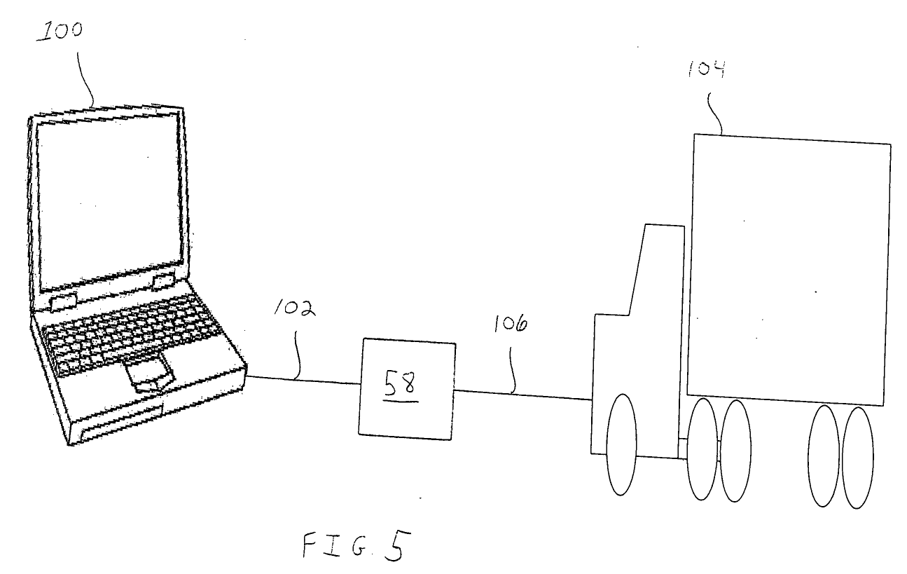

Referring to FIG. 5, there is shown a schematic diagram of one embodiment of the present invention using the communication system 40 or 80 of FIG. 3 or 4. As illustrated, a computer 100, such as the host computer 50 of FIG. 3 or FIG. 4, is connected to the Internet 58 with a first internet connection 102. The computer 100 may be a desktop computer, a laptop computer, a personal digital assistant (PDA) or a computer workstation. The computer 100 is configured with a diagnostic application, such as the diagnostic application 52 of FIG. 3 or FIG. 4, the first DLL interface 54, and the first computer network adapter driver 56 as described herein.

A truck 104 is connected to the Internet 58 with a second internet connection 106 as described herein. Using the components of FIG. 5, a technician (not shown) may obtain vehicle data from the truck 104 over the Internet 58. For instance, the technician and the computer 100 may be located at a first location, such as a fleet management complex or building, and the truck 104 may be located at a second location, such as a truck stop. Since many truck stops are configured with local area networks (LANs) and possess the ability for an onboard computer associated with the truck 104 to connect to the Internet, the technician may obtain vehicle data from the truck 104 over the Internet without having to be in close proximity to or establish a physical connection to the truck 104. Thus, the technician may obtain the vehicle data from the truck 104 that is located at a different or remote location. With the embodiment of FIG. 5, the technician is enabled to download vehicle data such as, for example, an error code stored on a microprocessor of a vehicle component control module associated with the onboard computer of the truck 104, perform a diagnostic session, or retrieve vehicle data from the truck 104.

Still referring to FIG. 5, a method of one embodiment of the present invention includes transferring the vehicle data from the truck 104 to the computer 100, a first connection is established between the computer 100 and a computer network, such as the Internet. A second connection is established between an onboard computer of the truck 104 and the Internet. A diagnostic application of the computer 100 sends and receives signals to the onboard computer or microprocessor of the vehicle component control module of the truck 104 utilizing the components and capabilities of the communication system 40 or 80 as described herein with reference to FIG. 3 or 4.

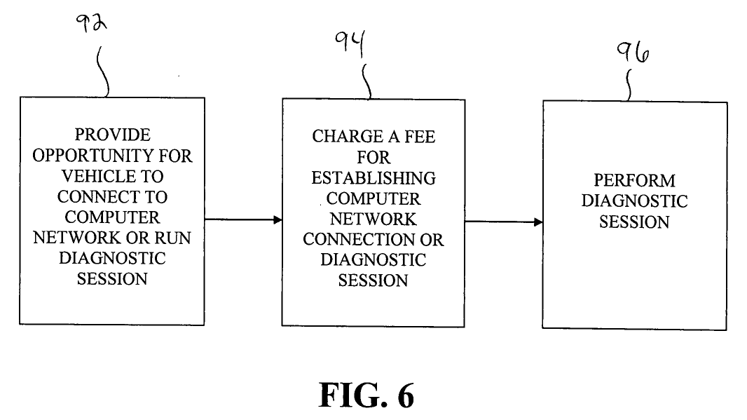

In another embodiment, the truck 104 or other vehicle may gain access to the computer network at a remote location by purchasing an opportunity to connect to the computer network via a hard wire or wireless connection at the remote location such as, for example, a truck stop. As shown in FIG. 6, a business, such as the truck stop, offers the vehicle an opportunity to connect to a computer network, have a diagnostic session performed, or both at box 92. In this manner, if the vehicle is traveling and experiences difficulties or if an error message or warning is reported by one of the vehicle control component modules associated with the vehicle, an operator of the vehicle may stop at the remote location and establish a connection to the computer network, e.g., the Internet, by paying a fee to a provider of the Internet connection, i.e., the truck stop. In one embodiment, the truck stop charges a fee for activating the service of establishing the connection to the computer network, charges a fee for the diagnostic session, or both as illustrated at box 94. Once the Internet connection is established, a technician or group of technicians are enabled to perform a remote diagnostic session as shown at box 96 on the vehicle over the Internet using the communication systems described herein.

In another embodiment, the Internet connection or diagnostic session may be activated by a pre-purchased “credit” card which may be swiped in a credit card payment device. Alternatively, the card payment device may be programmed to accept any major credit card. The fee may be a pre-set fee or a fee charged on a per minute on-line basis. The fee charged may be a fee to the technicians for performing the diagnostic session, a fee charged by the provider of the Internet connection, or both. In a further embodiment, the operator of the vehicle may establish a line of credit with the technicians for performing the diagnostic session or the provider of the Internet connection, wherein the operator accesses the line of credit by entering a code or recognizing an Internet Protocol (IP) address of the onboard computer of the vehicle.

The provider of the Internet connection may provide the connection for a monetary fee received by a credit card, cash, check, or the provider of the Internet connection may offer a subscription service wherein the vehicle may pay a set fee and gain access to the Internet connection. For example, an oil company may charge a periodic usage fee, such as annually, for an Internet connection at any of its gas stations. In another embodiment, the technician or group of technicians that perform the diagnostic session may charge a monetary fee to the vehicle for each system of the vehicle diagnosed or charge an hourly fee. In a further embodiment, a fee charged to the vehicle operator for the diagnostic session may include the fee for the Internet connection and the diagnostic session, wherein the fee may be charged by the provider of the Internet connection, or the technician or group of technicians.

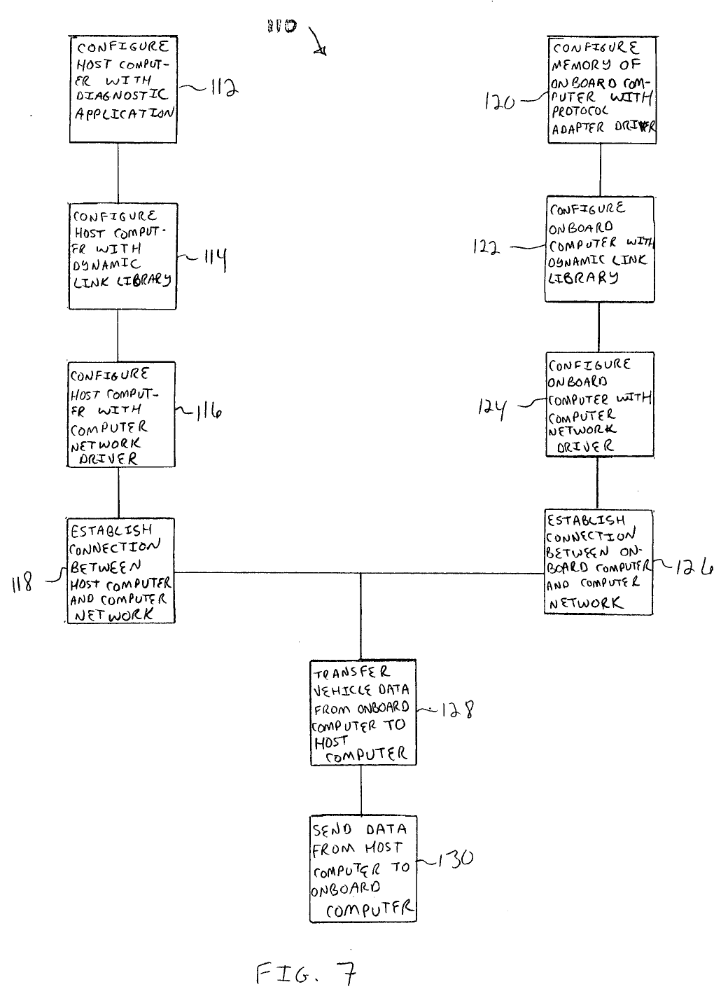

Referring now to FIG. 7, there is shown a flowchart of one embodiment of a method of performing a diagnostic session generally at 110. The method includes configuring the host computer with a diagnostic application at box 112, configuring the host computer with a DLL interface at box 114, and configuring the host computer with a computer network driver at box 116. A connection is established between the host computer and a computer network at box 118. The method further includes configuring memory of an onboard computer with a protocol adapter driver at box 120, configuring the onboard computer with a DLL interface at box 122, and configuring the onboard computer with a computer network driver at box 124. A connection is established between the onboard computer and the computer network at box 126. Once the connections are made on the computer network, vehicle data is transferred from the onboard computer to the host computer at box 128 and data is transferred from the host computer to the onboard computer at box 130. The method of performing the diagnostic session may be performed using any of the communication systems and various components described herein.

Having thus described certain exemplary embodiments of the present invention, it is to be understood that the invention defined by the appended claims is not to be limited by particular details set forth in the above description, as many apparent variations thereof are possible without departing from the spirit or scope thereof as hereinafter claimed.

1. A method of remotely performing a diagnostic session on a vehicle having an onboard computer, the method comprising:
establishing a first connection between a host computer and a computer network;
establishing a second connection between the onboard computer of a vehicle and the computer network; and
transferring vehicle data from the onboard computer of the vehicle to the host computer over the computer network.

2. The method according to claim 1, further comprising configuring the host computer with a diagnostic application.

3. The method according to claim 1, further comprising configuring the host computer with a dynamic link library interface.

4. The method according to claim 1, further comprising configuring the host computer with a computer network driver.

5. The method according to claim 1, wherein the computer network is the Internet.

6. The method according to claim 1, further comprising interconnecting the onboard computer to a protocol adapter.

7. The method according to claim 6, further comprising configuring a memory of the onboard computer with a protocol adapter driver.

8. The method according to claim 1, further comprising configuring a memory of the onboard computer with a dynamic link library interface.

9. The method according to claim 1, further comprising configuring a memory of the onboard computer with a computer network driver.

10. The method according to claim 1, further comprising sending data from the host computer to the onboard computer of the vehicle.

11-19. (canceled)

20. A system for remotely performing a diagnostic session comprising:
a host computer operatively configured with a diagnostic application, a first computer network adapter driver for connecting the host computer to a computer network, and a first dynamic link library interface for enabling the host computer to communicate with an onboard computer of a vehicle; and
the onboard computer having memory operatively configured with a second computer network adapter driver for connecting the onboard computer to the computer network and a protocol adapter driver for communicating with a protocol adapter;
wherein the onboard computer is associated with a vehicle component control module of a vehicle; and
a protocol adapter for interconnecting the onboard computer and the vehicle component control module.

21. The system of claim 20, further comprising a first computer network connection for connecting the host computer to the computer network.

22. The system of claim 21, further comprising a second computer network connection for connecting the onboard computer to the computer network.

23. The system of claim 20, wherein the computer network is the Internet.

24. The system of claim 20, wherein the host computer is selected from the group consisting of a desktop computer, a laptop computer, a personal digital assistant, and a computer workstation.

25. The system of claim 20, wherein the first dynamic link library is a RP1210A interface.

26. The system of claim 20, wherein the memory device of the onboard computer is further configured with a second dynamic link library interface for enabling the computer to communicate with the onboard computer.

27. The system of claim 20, further comprising a means for connecting the host computer to the computer network.

28. The system of claim 20, further comprising a means for connecting the onboard computer to the computer network.

29. The system of claim 20, wherein the vehicle is selected from the group consisting of a truck, an automobile, a piece of heavy equipment, a piece of construction equipment, a farm machine and a military vehicle.

30. The system of claim 20, further comprising a vehicle network for enabling the protocol adapter to communicate with the vehicle component control module.

31. The system of claim 30, wherein the vehicle network is selected from the group consisting of J1708, J1850, CAN, J1587, J1939 and J1922.

32. The system of claim 20, wherein the onboard computer is associated with a plurality of vehicle component control modules.

33. The system of claim 20, wherein the vehicle component control module is selected from the group consisting of a HVAC control module, a brake control module, a transmission control module, and an engine control module 32d.

34-42. (canceled)

43. A method of performing a diagnostic session on a vehicle remotely located from a host computer configured with a diagnostic application, the method comprising:
activating a connection between an onboard computer of the vehicle and the Internet, thus connecting to the host computer to the onboard computer;
accessing the Internet to establish communication between the onboard computer and the host computer; and
performing the diagnostic session on the remotely located vehicle over the Internet by running the diagnostic application.

44. The method according to claim 43, wherein activating the connection is facilitated by purchasing the connection for a monetary fee.

45. The method according to claim 43, wherein activating the connection between the onboard computer and the host computer is performed at a truck stop.

46. The method according to claim 43, wherein performing the diagnostic session comprises transferring vehicle data from the onboard computer of the vehicle to the host computer over the Internet.
